(19) United States
(12) Patent Application Publication
(10) Pub. No.: US 2025/0379225 A1
(43) Pub. Date: Dec. 11, 2025

(54) LOW COST ALUMINUM-IRON ANODE ELECTRODE FOR ALL-SOLID-STATE BATTERY CELLS

(71) Applicant: GM GLOBAL TECHNOLOGY OPERATIONS LLC, Detroit, MI (US)

(72) Inventors: Zhe LI, Shanghai (CN); Qili SU, Shanghai (CN); Henry ZHAN, Shanghai (CN); Haijing LIU, Shanghai (CN); Congjie WANG, Shanghai (CN)

(21) Appl. No.: 18/774,434

(22) Filed: Jul. 16, 2024

(30) Foreign Application Priority Data
Jun. 7, 2024 (CN) 2024107409573

(51) Int. Cl. H01M 4/46; H01M 4/02; H01M 4/134; H01M 10/0562

(52) U.S. Cl. CPC H01M 4/46; H01M 4/134; H01M 10/0562; H01M 2004/021; H01M 2004/027; H01M 2004/028; H01M 2300/0068

(57) ABSTRACT

An all-solid-state-battery (ASSB) cell includes C cathode electrodes, S separators, and A anode electrodes, where A, C and S are integers greater than zero. Each of the A anode electrodes comprises an aluminum-iron (Al—Fe) layer and a prelithiated Al—Fe layer on the Al—Fe layer.

### CROSS-REFERENCE TO RELATED APPLICATIONS

This application claims the benefit of Chinese Patent Application No. 202410740957.3 filed on Jun. 7, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to an all-solid-state battery (ASSB) including an anode electrode including an aluminum-iron layer and a prelithiation layer.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

An all-solid-state-battery (ASSB) cell includes C cathode electrodes, S separators, and A anode electrodes, where A, C and S are integers greater than zero. Each of the A anode electrodes comprises an aluminum-iron (Al—Fe) layer and a prelithiated Al—Fe layer on the Al—Fe layer.

In other features, the prelithiated Al—Fe layer is arranged adjacent to one of the S separators. The Al—Fe layer is arranged adjacent to one of the S separators and the prelithiated Al—Fe layer is arranged between a current collector and the Al—Fe layer. The Al—Fe layer comprises Al in a range from 97.0 wt % to 99.5 wt % and Fe in a range from 0.5 wt % to 2.0 wt %.

In other features, the Al—Fe layer comprises silicon in a range from 0.01 wt % to 0.8 wt %. A thickness of the Al—Fe layer is in a range from 2 μm to 40 μm. A thickness of the prelithiated Al—Fe layer is in a range from 1 μm to 60 μm. A grain boundary distribution (>15°) of the Al—Fe layer is in a range from 20% to 45%. The prelithiated Al—Fe layer further comprises one of lithium element composite in a range from 0.02 mg/cm² to 1.30 mg/cm².

In other features, the S separators comprise solid electrolyte in a range from 10 to 100 wt %. The solid electrolyte comprises at least one of a binder comprising 1 to 20 wt %, and at least one of a conductive filler and/or a skeleton frame comprising 0.5 wt % to 50 wt %.

In other features, the C cathode electrodes comprise cathode active material in a range from 30 to 98 wt %, and at least one of solid electrolyte in a range from 1 to 50 wt %, a conductive additive in a range from 1 to 30 wt %, and a binder in a range from 1 to 20 wt %.

In other features, the C cathode electrodes comprise cathode active material selected from a group consisting of rock salt layered oxides, spinel, polyanion cathode, olivine cathode, other lithium transition-metal oxides, surface coated or doped cathode materials, and lithiated metal oxide/sulfides.

An anode electrode for all-solid-state-battery (ASSB) cell includes an aluminum-iron (Al—Fe) layer comprising Al in a range from 97.0 wt % to 99.5 wt % and Fe in a range from 0.5 wt % to 2.0 wt % and a prelithiated Al—Fe layer on the Al—Fe layer.

In other features, the Al—Fe layer further comprises silicon in a range from 0.05 wt % to 0.8 wt %. A thickness of the Al—Fe layer is in a range from 2 μm to 40 μm. A thickness of the prelithiated Al—Fe layer is in a range from 1 μm to 60 μm. A grain boundary distribution (>15°) of the Al—Fe layer is in a range from 20% to 45%. The prelithiated Al—Fe layer further comprises a lithium element in a range from 0.02 mg/cm² to 1.30 mg/cm².

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell according to the present disclosure;

FIG. 2 is an enlarged side cross section of an example of the battery cell according to the present disclosure;

FIG. 3 is an enlarged side cross section of an example of the battery cell according to the present disclosure;

FIGS. 4A and 4B illustrate grain boundaries of an example of the prelithiated Al—Fe layer/Al—Fe layer according to the present disclosure;

FIGS. 5 and 6 are energy dispersive spectroscopy elemental mappings of examples of the prelithiated Al layer and a pre-lithiated Al—Fe layer, respectively, according to the present disclosure;

FIG. 7 is a graph illustrating an X-ray diffraction pattern for examples of an Al layer, a prelithiated Al layer, an Al—Fe layer, and a prelithiated Al—Fe layer according to the present disclosure;

FIG. 8 is a graph illustrating voltage as a function of capacity for examples of a prelithiated Al layer/Al layer and a prelithiated Al—Fe layer/Al—Fe layer according to the present disclosure; and

FIG. 9 is a graph illustrating capacity as a function of cycles for examples of a prelithiated Al layer/Al layer and a prelithiated Al—Fe layer/Al—Fe layer during 0.2 C cycling according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

All-solid-state battery (ASSB) cells are likely to be the next generation energy storage technology due to good abuse tolerance, wide operating temperature range, and simplified construction. The anode electrode typically includes a graphite anode layer arranged on a copper current collector to enable good electrochemical cycling. However, graphite-based anode electrodes have lower energy density due to the limited theoretical energy specific capacity of graphite (372 mAh/g) and the introduction of inactive components such as the copper current collector and solid electrolyte.

An all-solid-state battery (ASSB) cell according to the present disclosure includes an anode electrode including low-cost aluminum-iron (Al—Fe) layer such as foil and a prelithiated layer formed on it. The anode electrode improves energy density and reduces material/manufacturing cost. The prelithiated Al—Fe foil acts as both an active lithium storage medium and a current collector that works with a separator including solid electrolyte.

Due to the integrated anode electrode structure, only a 2D-plane interface is formed between the anode electrode and the separator layer (e.g., solid electrolyte such as sulfide-based solid electrolyte). This approach effectively reduces the forming area of the solid electrolyte interface (SEI) as compared to battery cells using liquid electrolyte. The introduction of Fe atoms into the Al layer increases the grain boundary distribution to facilitate lithium-ion diffusion. As a result, the prelithiated Al—Fe layer demonstrates an enhanced initial Coulombic efficiency and increased capacity delivery. Removing graphite as the anode active material and copper as the anode current collector will reduce the cost and enhance the energy density of the ASSB cells.

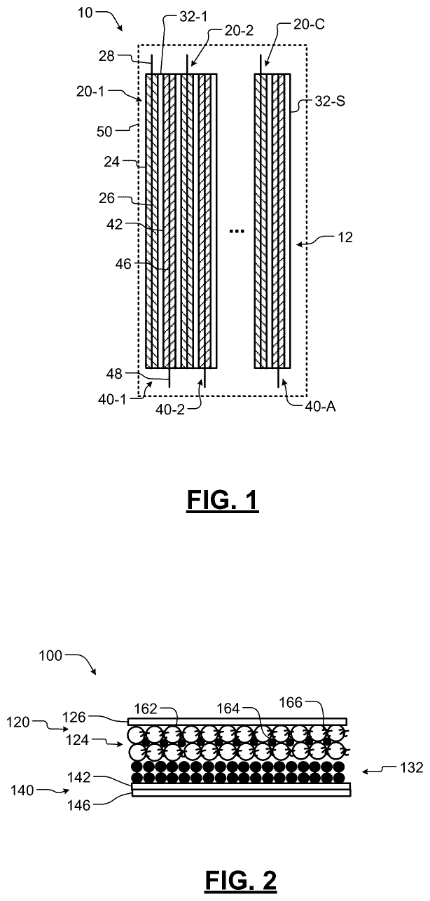

Referring now to FIG. 1, an all-solid-state battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include a prelithiation layer 42 formed on an Al—Fe layer 46.

During charging/discharging, the A anode electrodes 40 and the C cathode electrodes 20 exchange lithium ions. In some examples, the cathode active material layers 24 comprise coatings including one or more active materials, one or more conductive additives, and/or one or more binder materials that are applied to the current collectors.

In some examples, the cathode current collector 26 comprises metal foil, metal mesh, perforated metal, 3 dimensional (3D) metal foam, and/or expanded metal. In some examples, the current collectors are made of one or more materials selected from a group consisting of stainless steel, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIG. 2, an example of a battery cell 100 is shown. A cathode electrode 120 includes a cathode active material layer 124 arranged on a cathode current collector 126. A separator 132 including solid electrolyte is arranged adjacent to the cathode electrode 120. An anode electrode 140 includes an Al—Fe layer 146 and a prelithiated Al—Fe layer 142 arranged between the Al—Fe layer 146 and the separator 132.

In some examples, the Al—Fe layer 146 with the prelithiated Al—Fe layer 142 acts as both an active material layer and a current collector. In some examples, the Al—Fe layer 146 comprises aluminum in a range from 97.0 wt % to 99.5 wt % and iron (Fe) in a range from 0.5 wt % to 2.0 wt % (e.g., 1.1 wt %). In some examples, the Al—Fe layer 146 optionally comprises silicon in a range from 0.01 wt % to 0.8 wt %. In some examples, the Al—Fe layer 146 has a thickness in a range from 2 μm to 40 μm (e.g., 10 μm). In some examples, the grain boundary distribution is defined to be greater than 15%. In some examples, the grain boundary distribution is in a range from 20% to 45%. In some examples, the grain boundary distribution is in a range from 30% to 45% (e.g., 35.5 wt %). In some examples, the Al—Fe layer comprises Al—Fe, Al—Fe—Si, or 8021 foil that are inexpensive and widely used in packaging material. The Al—Fe layer is chemical resistant and has excellent electrical properties and is non-magnetic.

In some examples, the prelithiated Al—Fe layer 142 acts as the anode active material and lithium-ion conductor and compensates for active lithium loss. In some examples, the prelithiated Al—Fe layer 142 is formed by prelithiation of Al—Fe layer 146, and further comprises lithium in a range from 0.02 mg/cm² to 1.30 mg/cm². In some examples, the prelithiated Al—Fe layer 142 has a thickness in a range from 1 μm to 60 μm. In some examples, the prelithiated Al—Fe layer 142 has a thickness in a range from 25 μm to 50 μm (e.g., 35 μm).

Due to the integrated anode structure, only a 2D plane interface is formed between the anode electrode and the separator layer (solid electrolyte). The 2D interface reduces the forming area of the solid electrolyte interface as compared to battery cells using liquid electrolyte. The anode electrode only expands in a direction perpendicular to the electrode/separator interface. The expansion produces additional external pressure alleviating contact problems between the anode electrode and the solid electrolyte in the separator. In some examples, the Al—Fe layer has a higher grain boundary misorientation as compared to an Al layer.

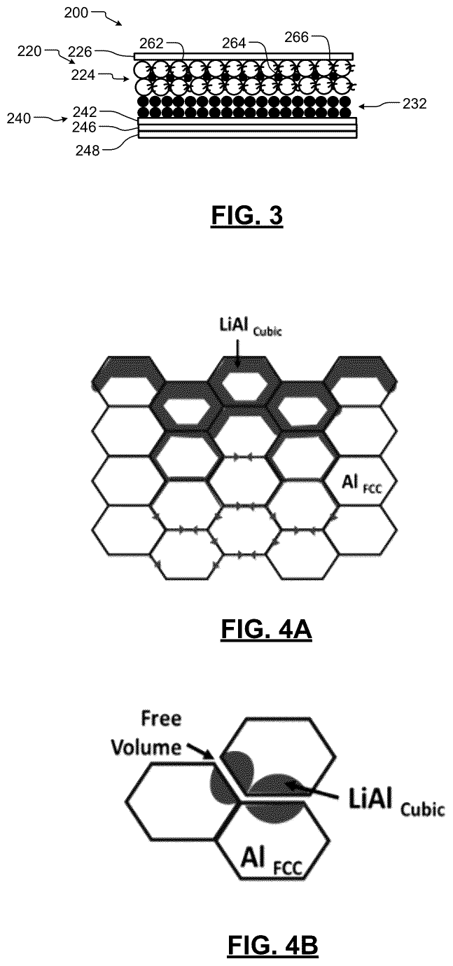

Referring now to FIG. 3, another example of a battery cell 200 is shown. A cathode electrode 220 includes a cathode active material layer 224 arranged on a cathode current collector 226. A solid electrolyte layer 232 is arranged adjacent to the cathode electrode 220. An anode electrode 240 includes an Al—Fe layer 242, a prelithiated Al—Fe layer 246, and a current collector 248. In some examples, the current collector 248 comprises copper foil.

Referring now to FIGS. 4A and 4B, grain boundaries of an example of the Al—Fe layer are illustrated. The introduction of Fe atoms in the Al layer increases the grain boundary distribution which facilitates lithium ion diffusion. As a result, the grain boundary diffusion during lithiation will create free volume in situ (as shown in FIG. 4B) such that the Li diffusion ability along the grain boundaries is enhanced for future Li invasion. Grain boundary diffusion is the fastest diffusion path as compared to other paths such as phase boundaries, dislocation cores, or lattice.

In contrast, for Li atom diffusion in LiAl/Al phase boundaries, their interface is not going to change much. The phase boundaries move vertically and are relatively invariant such that it keeps a relatively low diffusion ability.

In some examples, the solid electrolyte layer comprises solid electrolyte in a range from 10 to 100 wt %, an optional binder comprising 1 to 20 wt %, and a conductive filler and/or skeleton frame comprising 0.5 wt % to 50 wt %. In some examples, the solid electrolyte layer is prepared using a wet coating process, a dry film process or other suitable process.

In some examples, the solid electrolyte is selected from a group consisting of pseudobinary sulfide solid electrolyte, pseudoternary sulfide solid electrolyte, pseudoquaternary sulfide solid electrolyte, a halide-based solid electrolyte, a hydride-based solid electrolyte, or other solid electrolyte that has low grain boundary resistance.

Examples of pseudobinary sulfide include Li₂S—P₂S₅ system (Li₅PS₄, Li₂P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₅ system, Li₂S—Ga₂S₅ system, Li₂S—P₂S₅ system, and Li₂S—Al₂S₅ system.

Examples of pseudoternary sulfide include Li₂O—Li₂S—P₂S₅ system, Li₂S—P₂S₅—P₂O₅ system, Li₂S—P₂S₅—GeS₂ system, (Li_{3.25}Ge_{0.25}P_{0.75}S₄ and Li₁₀GeP₂S₁₂), Li₂S—P₂S₅—LiX system (where X=F, Cl, Br, I), (Li₅PS₅Br, Li₆PS₅Cl, L₇P₂S₅I and Li₄PS₄I), Li₂S—As₂S₅—SnS₂ system, (Li_{3.833}Sn_{0.833}As_{0.166}S₄) system, Li₂S—P₂S₅—Al₂S₃ system, Li₂S—LiX—SiS₂ system (where X=F, Cl, Br, I), 0.4LiI-0.6Li₄SnS₄, and Li₁₁Si₂PS₁₂.

Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

Examples of the halide-based sulfide electrolyte include Li₃YCl₆, Li₅InCl₆, Li₃YBr₆, LiI, Li₂CdC₁₄, Li₂MgC₁₄, Li₂Cd₁₄, Li₂Zn₁₄, and Li₃OCl. Examples of the hydride-based sulfide electrolyte include LiBH₄, LiBH₄—LiX (X=Cl, Br, or I), LiNH₂, Li₂NH, LiBH₄—LiNH₂, and Li₃AlH₆.

In some examples, the binder is selected from a group consisting of polytetrafluoroethylene (PTFE), sodium carboxymethyl cellulose (CMC), styrene butadiene rubber (SBR), poly(vinylidene fluoride) (PVDF), nitrile butadiene rubber (NBR), hydrogenated NBR (HNBR), styrene ethylene butylene styrene copolymer (SEBS), poly(vinylidene fluoride-co-hexafluoropropylene) (PVDF-HFP), polyethylene oxide (PEO), polyacrylonitrile (PAN), polyacrylic acid (PAA), and styrene butadiene copolymer (SBS).

Examples of the conductive filler and/or the skeleton frame include lithium salts (such as LiTFSI, LiFSI, LiBF₄, LiClO₄, etc.), oxide-based solid electrolyte (such as garnet type (e.g., Li₂La₃Zr₂O₁₂), (e.g., Li₃ₓLa_{2/3x}TiO₃), NASICON type (e.g., Li_{1.4}Al_{0.4}Ti_{1.6}(PO₄)₃, and Li₁₊ₓAlₓGe₂₋ₓ(PO₄)₃), LISICON type (e.g., Li₂₊₂ₓZn₁₋ₓGeO₄). nitrile-based solid electrolyte, halide-based solid electrolyte, hydride-based solid electrolyte, ceramic oxides (e.g., SiO₂, Al₂O₃, TiO₂, ZrO₂, etc.), polyester nonwoven, a cellulose separator, a PVDF membrane, polytetrafluoroethylene, polyethylene terephthalate, porous polyimide membrane, a polyolefin-based separator (such as polyacetylene, polypropylene (PP), dual layer PP-PE, three layer PP-PE-PP), a ceramic coated membrane (e.g., polyimide (PI) nanofiber-based nonwovens, co-polyimide-coated polyethylene separators, or an expanded polytetrafluoroethylene reinforced polyvinylidenefluoride-hexafluoropropylene separator).

In some examples, the cathode electrode is prepared using a wet coating process, a dry film process or a dry powder coating process. In some examples, the cathode electrode comprises cathode active material in a range from 30 to 98 wt %, optional solid electrolyte in a range from 1 to 50 wt %, optional conductive additive in a range from 1 to 30 wt % and optional binder in a range from 1 to 20 wt %.

In some examples, the cathode active material is selected from a group consisting of rock salt layered oxides, spinel, polyanion cathode, olivine cathode, other lithium transition-metal oxides, surface coated or doped cathode materials (described above), low voltage cathode materials such as lithiated metal oxide/sulfides. Examples of rock salt layered oxides include LiCoO₂, LiNiₓMn_{y}Co_{1-x-y}O₂, LiNiₓMn_{y}Al_{1-x-y}O₂, LiNiₓMn₁₋ₓO₂, Li₁₊ₓMO₂, where M is a transition metal. Examples of spinel compounds include LiMn₂O₄ and LiNi_{0.5}Mn_{1.5}O₄. Examples of olivine compounds include LiV₂(PO₄)₃, LiFePO₄, and LiMnₓFe₁₋ₓPO₄.

In some examples, the conductive additive is selected from a group consisting of carbon black, graphite, graphene, graphene oxide, Super P, acetylene black, carbon nanotubes, or other electrically conductive additives. In some examples, the binder is selected from a group consisting of PTFE, sodium CMC, SBR, PVDF, NBR, SEBS, PVDF-HFP, PEO, PAN, PAA, SBS, etc.

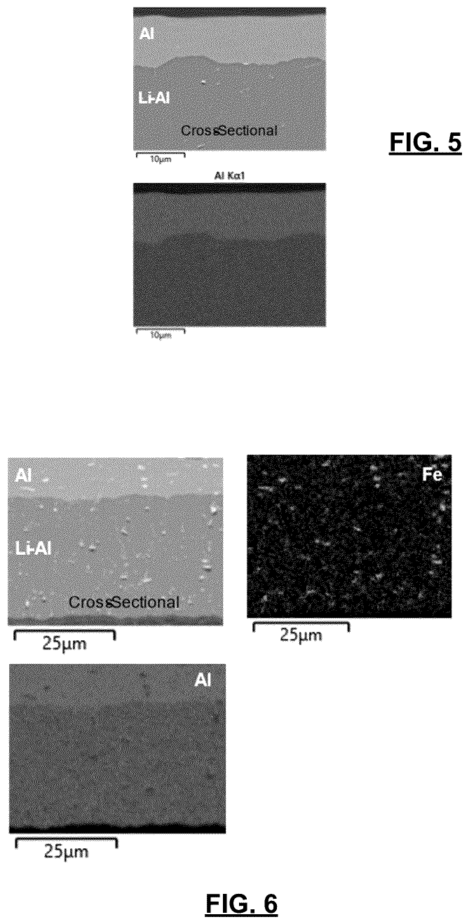

Referring now to FIGS. 5 and 6, energy dispersive spectroscopy elemental mappings are shown for examples of the prelithiated Al layer and a pre-lithiated Al—Fe layer, respectively. As can be seen in FIG. 6, the Fe elements of the pre-lithiated Al—Fe layer are uniformly distributed in the Al matrix.

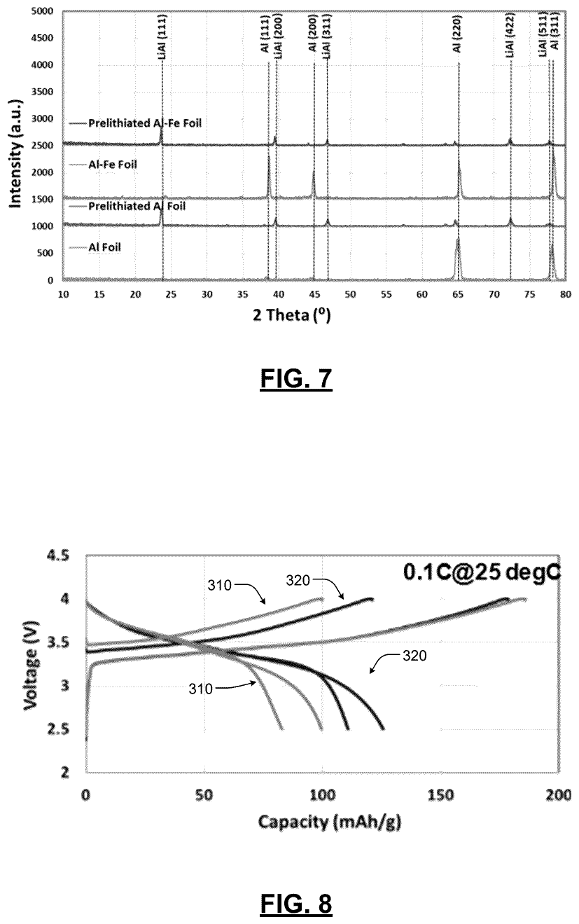

Referring now to FIG. 7, a graph illustrating an X-ray diffraction pattern for examples of Al layer, prelithiated Al layer, Al—Fe layer and prelithiated Al—Fe layer are shown. The peaks of the prelithiated Al—Fe layer and Al layer are consistent with standard data for LiAl crystals in the inorganic crystal structure database (ICSD).

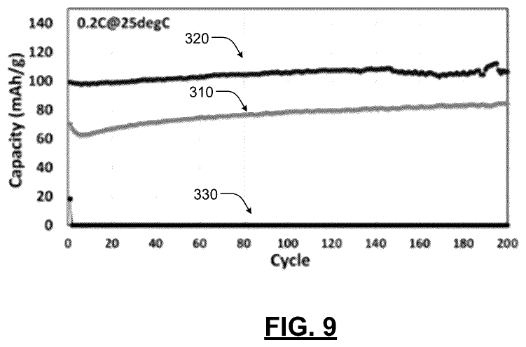

Referring now to FIGS. 8 and 9, performance of battery cells including the anode of prelithiated Al layer/Al layer and the anode of prelithiated Al—Fe layer/Al—Fe layer are shown. In FIG. 8, voltage is shown as a function of capacity (mAh/g) for examples of the anode of prelithiated Al layer/Al layer and the anode of prelithiated Al—Fe layer/Al—Fe layer during initial charge and discharge at 0.1 C at 25° C. In FIG. 9, capacity is shown as a function of cycles for examples of the anode of prelithiated Al layer/Al layer, the anode of prelithiated Al—Fe layer/Al—Fe layer, and the anode of Al layer only at 330 during 0.2 C cycling according to the present disclosure.

The anode of prelithiated Al—Fe layer/Al—Fe layer had an initial coulombic efficiency of 70% and an initial discharge of 126 mAh/g while the anode of prelithiated Al layer/Al layer had an initial coulombic efficiency of 54% and an initial discharge of 100 mAh/g. As can be appreciated, the anode of prelithiated Al—Fe layer/Al—Fe layer demonstrates enhanced initial Coulombic efficiency and increased capacity delivery due to the boosted Li+ diffusion pathways.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. An all-solid-state-battery (ASSB) cell, comprising:
C cathode electrodes;
S separators; and
A anode electrodes, where A, C and S are integers greater than zero,
wherein each of the A anode electrodes comprises:
an aluminum-iron (Al—Fe) layer; and
a prelithiated Al—Fe layer on the Al—Fe layer.

2. The ASSB of claim 1, wherein the prelithiated Al—Fe layer is arranged adjacent to one of the S separators.

3. The ASSB of claim 1, further comprising a current collector, wherein the Al—Fe layer is arranged adjacent to one of the S separators and the prelithiated Al—Fe layer is arranged between the current collector and the Al—Fe layer.

4. The ASSB of claim 1, wherein the Al—Fe layer comprises Al in a range from 97.0 wt % to 99.5 wt % and Fe in a range from 0.5 wt % to 2.0 wt %.

5. The ASSB of claim 4, wherein the Al—Fe layer comprises silicon in a range from 0.01 wt % to 0.8 wt %.

6. The ASSB of claim 1, wherein a thickness of the Al—Fe layer is in a range from 2 μm to 40 μm.

7. The ASSB of claim 1, wherein a thickness of the prelithiated Al—Fe layer is in a range from 1 μm to 60 μm.

8. The ASSB of claim 1, wherein a grain boundary distribution (>15°) of the Al—Fe layer is in a range from 20% to 45%.

9. The ASSB of claim 1, wherein the prelithiated Al—Fe layer further comprises a lithium element in a range from 0.02 mg/cm² to 1.30 mg/cm².

10. The ASSB of claim 1, wherein the S separators comprise solid electrolyte in a range from 10 to 100 wt %.

11. The ASSB of claim 10, wherein the solid electrolyte comprises at least one of:
a binder comprising 1 to 20 wt %, and
at least one of a conductive filler and/or a skeleton frame comprising 0.5 wt % to 50 wt %.

12. The ASSB of claim 1, wherein the C cathode electrodes comprise:
cathode active material in a range from 30 to 98 wt %, and
at least one of:
solid electrolyte in a range from 1 to 50 wt %,
a conductive additive in a range from 1 to 30 wt %, and
a binder in a range from 1 to 20 wt %.

13. The ASSB of claim 1, wherein the C cathode electrodes comprise cathode active material selected from a group consisting of rock salt layered oxides, spinel, polyanion cathode, olivine cathode, other lithium transition-metal oxides, surface coated or doped cathode materials, and lithiated metal oxide/sulfides.

14. An anode electrode for all-solid-state-battery (ASSB) cell, comprising:
an aluminum-iron (Al—Fe) layer comprising Al in a range from 97.0 wt % to 99.5 wt % and Fe in a range from 0.5 wt % to 2.0 wt %; and
a prelithiated Al—Fe layer on the Al—Fe layer.

15. The anode electrode of claim 14, further comprising a current collector, wherein the prelithiated Al—Fe layer is arranged between the current collector and the Al—Fe layer.

16. The anode electrode of claim 14, wherein the Al—Fe layer further comprises silicon in a range from 0.05 wt % to 0.8 wt %.

17. The anode electrode of claim 14, wherein a thickness of the Al—Fe layer is in a range from 2 μm to 40 μm.

18. The anode electrode of claim 14, wherein a thickness of the prelithiated Al—Fe layer is in a range from 1 μm to 60 μm.

19. The anode electrode of claim 14, wherein a grain boundary distribution (>15°) of the Al—Fe layer is in a range from 20% to 45%.

20. The anode electrode of claim 14, wherein the prelithiated Al—Fe layer further comprises a lithium element in a range from 0.02 mg/cm² to 1.30 mg/cm².
